(19) United States
(12) Patent Application Publication
(10) Pub. No.: US 2017/0060974 A1
(43) Pub. Date: Mar. 2, 2017

(54) AUTOMATED CONVERSION TOOL FOR FACILITATING MIGRATION BETWEEN DATA INTEGRATION PRODUCTS

(71) Applicant: Jade Global, Inc., San Jose, CA (US)

(72) Inventors: Vijaykumar Dudhani, Fremont, CA (US); Ashok Paramasivam, Madurai (IN); Husain Merchant, Pune (IN); Amit Raj, San Jose, CA (US)

(21) Appl. No.: 15/244,924

(22) Filed: Aug. 23, 2016

Related U.S. Application Data
(60) Provisional application No. 62/212,399, filed on Aug. 31, 2015.

(51) Int. Cl. G06F 17/30; G06F 3/0482

(52) U.S. Cl. CPC G06F 17/30569; G06F 3/0482

(57) ABSTRACT

Techniques for automatically converting data integration (DI) metadata between two different types of DI products are provided. According to one embodiment, a computer system can execute one or more pre-conversion tasks with respect to first DI metadata used by a first DI product, where the one or more pre-conversion tasks including exporting the first DI metadata into an intermediate format. The computer system can then convert, in an automated or semi-automated manner, the first DI metadata from the intermediate format into second DI metadata usable by a second DI product.

### CROSS-REFERENCES TO RELATED APPLICATIONS

The present application claims the benefit and priority of U.S. Provisional Application No. 62/212,399, filed Aug. 31, 2015, entitled “Automated Conversion Tool for Facilitating Migration Between Data Integration Products,” the entire contents of which are incorporated herein by reference in its entirety for all purposes.

### BACKGROUND

In computing, “data integration” refers to the process of combining data from disparate sources in a manner that allows users to have a unified and meaningful view of the data. For example, data integration is commonly used to extract data from transactional systems, transform the extracted data into a common format/schema, and store the transformed data in a data warehouse. The data in the data warehouse can then be used for various purposes, such as reporting, data analysis/mining, and so on.

There are a number of data integration (DI) software products that are commercially available today. Examples of such DI products include Informatica and Oracle Data Integrator (ODI). These DI products generally enable users to define metadata (referred to herein as data integration (DI) metadata) that specifies how the data integration process should be carried out. For instance, in Informatica, a user can define a type of DI metadata known as a “mapping” that includes a source object (i.e., a source file or database table), a target object (i.e., a destination file or database table), and one or more transformation objects linked between the source object and the target object. These transformation objects can include aggregators, expressions, filters, routers, sequence generators, source qualifiers, stored procedures, and more. At runtime, Informatica can apply the transformations specified in the mapping to extract, transform, and load data from the source to the target in accordance with the user's requirements.

Similarly, in ODI, a user can define a type of DI metadata known as an “interface.” ODI interfaces are functionally comparable to Informatica mappings in that they specify transformations that govern the data integration process between a source and a target. However, since Informatica and ODI are developed by different software vendors, an Informatica mapping is not directly interchangeable with an ODI interface. For example, an Informatica mapping is structured according to an Extract-Transform-Load (ETL) paradigm, whereas an ODI interface is structured according to an Extract-Load-Transform (ELT) paradigm. Further, beyond mappings, there are other types of Informatica metadata objects that are functionally similar to ODI metadata objects but are not directly interchangeable. Yet further, Informatica supports certain types of metadata objects and features that are not supported by ODI, and vice versa.

This metadata incompatibility between different DI products like Informatica and ODI can be a significant hurdle for customers that wish to migrate from one DI product to another. For instance, assume that a customer has used Informatica for a number of years and developed a large library of custom Informatica mappings to support its computing deployments. Further assume that the customer decides to migrate from Informatica to ODI for one or more reasons (e.g., lower operational costs, better support, better integration/compatibility with other software, etc.). In this scenario, the customer would need to manually create new ODI interfaces that enable the DI processes previously enabled by the old Informatica mappings. Such a manual endeavor can be time-consuming, error-prone, and potentially expensive (due to, e.g., the need to employ experts/consultants that are familiar with the metadata formats of both DI products).

### SUMMARY

Techniques for automatically converting data integration (DI) metadata between two different types of DI products are provided. According to one embodiment, a computer system can execute one or more pre-conversion tasks with respect to first DI metadata used by a first DI product, where the one or more pre-conversion tasks including exporting the first DI metadata into an intermediate format. The computer system can then convert, in an automated or semi-automated manner, the first DI metadata from the intermediate format into second DI metadata usable by a second DI product.

The following detailed description and accompanying drawings provide a better understanding of the nature and advantages of particular embodiments.

### BRIEF DESCRIPTION OF DRAWINGS

FIG. 1 depict a system environment that supports automated conversion of DI metadata according to an embodiment.

FIG. 2 depicts an example computer system according to an embodiment.

FIGS. 3A, 3B, 3C, and 3D depict a high-level workflow for performing automated conversion of DI metadata according to an embodiment.

FIGS. 4-34 depict various graphical user interfaces (UIs) for implementing an Informatica-to-ODI metadata conversion according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

The present disclosure describes a tool for automatically converting DI metadata used by a first DI software product into corresponding DI metadata used by a second DI software product. With this tool, customers who are migrating from the first DI product to the second DI product can more easily and efficiently carry out the migration, since there is no need to manually recreate the original DI metadata used by the first product according to the requirements/specifications of the second product. Instead, the conversion tool can handle the majority of this work in an automated manner. In cases where the original DI metadata is too complex to be converted automatically by the conversion tool, the tool can provide a semi-automated mode in which a user can provide input for guiding the conversion process. Further, in cases where a particular instance of the original DI metadata (e.g., a mapping/interface) has already been converted into a format used by the second DI product, but the original mapping/interface has been modified to include custom columns/transformations that were not previously converted, the tool can partially convert those columns/transformations without having to reconvert the entire mapping/interface.

The foregoing and other aspects of the present disclosure are described in further detail below. It should be noted that, for purposes of illustration, in certain embodiments/examples it is assumed that the first (i.e., conversion source) DI product is Informatica and the second (i.e., conversion target) DI product is ODI. However, it should be appreciated that the techniques described herein may be generically applied to enable conversion of DI metadata between any two DI products.

### 2. System Architecture

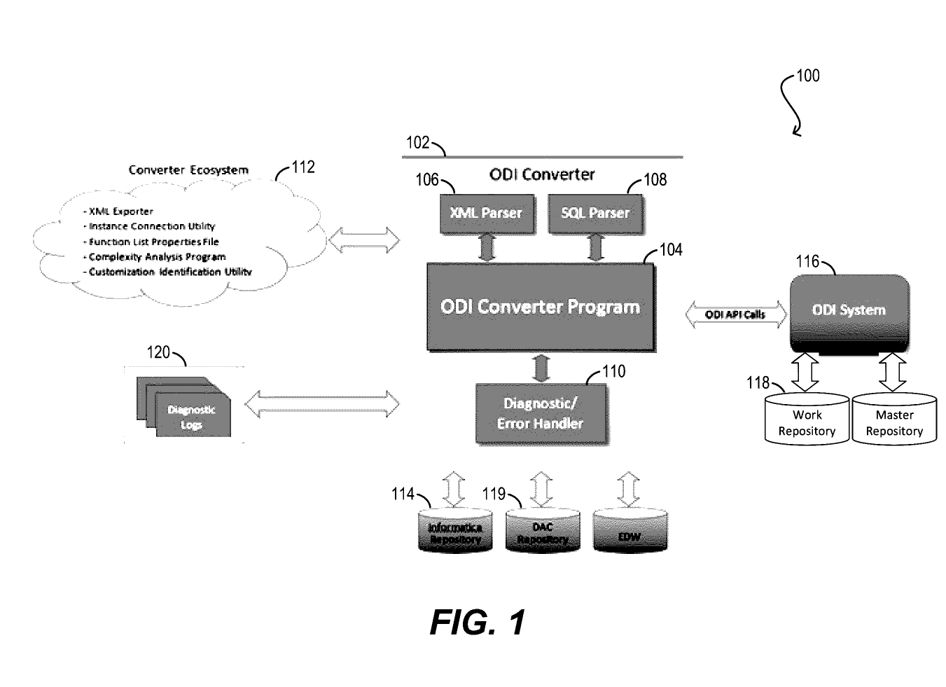

FIG. 1 depicts a system architecture 100 that supports automated conversion of DI metadata according to an embodiment. As shown, system architecture 100 includes a conversion tool 102 (identified here as an “ODI converter”) that comprises a core converter program 104, an XML parser 106, an SQL parser 108, and a diagnostic/error handler 110. In addition, conversion tool 102 makes use of a number of supporting files/programs that collectively comprise a “converter ecosystem” 112. These supporting files/programs include an XML exporter, an instance connection utility, a function list properties files, a complexity analysis program, and a customization identification utility. The roles of these ecosystem components are discussed below.

Generally speaking, at runtime, conversion tool 102 can retrieve DI metadata used by a first (i.e., conversion source) DI product from a conversion source repository 114 (identified here as an “Informatica Repository”). In one embodiment, this conversion source DI metadata can be retrieved in the form of one or more XML files (that are exported via, e.g., the XML exporter of converter ecosystem 112). Conversion tool 102 can then convert, either in a full (e.g., bulk or semi-automated) or partial conversion mode, the conversion source DI metadata into metadata that is usable by a second (i.e., conversion target) DI product. As part of this step, conversion tool 102 can invoke one or more APIs exposed by an instance 116 of the conversion target DI product (identified here as an “ODI system”) for generating the conversion target DI metadata. Conversion tool 102 can also read DAC metadata from a DAC repository 119 during the conversion process. Once this conversion is complete, conversion tool 102 can compile and store the converted metadata in an underlying work repository 118 accessible by the conversion target DI product. Conversion tool 102 can also store diagnostic logs that are generated during the conversion process (by, e.g., diagnostic/error handler 110) in a diagnostic data store 120.

In some embodiments, conversion tool 102 can perform the conversion process described above in the context of a bulk conversion workflow. In this bulk conversion workflow, a tool user can select a number of existing mappings/interfaces used by the conversion source DI product and can request that conversion tool 102 automatically convert, to the best of its ability, the selected mappings/interfaces into equivalent mappings/interfaces used by the conversion target DI product. Note that this bulk conversion will generally work best with relatively simple mappings/interfaces that include certain predefined types of objects.

In further embodiments, conversion tool 102 can also provide a manually-assisted conversion workflow in which tool 102 parses the definition for a given conversion source mapping/interface and then displays the objects included in the mapping/interface to a user. The user can then select the specific objects that he/she wishes to include in the conversion target mapping/interface, along with providing other information used to facilitate the conversion process (e.g., breakpoint definitions, etc.). Conversion tool 102 can then attempt to convert the selected objects into conversion target equivalents and can display the results to the user for review. Upon reviewing the results, the user can modify aspects of the converted objects in order to more correctly mirror the conversion source mapping/interface. The user can then finalize and save the conversion target mapping/interface. This manually-assisted workflow is useful for more complex mappings that conversion tool 102 may not be capable of converting automatically by itself (and thus require some user intervention/input for guiding the conversion process).

In yet further embodiments, conversion tool 102 can provide a partial conversion workflow that is applicable when a customer/user may already have conversion target mappings/interfaces that correspond to conversion source mappings/interfaces, but the customer wishes to propagate certain customized transformations on a few fields/columns of the conversion source mappings/interfaces to the conversion target mappings/interfaces. In this workflow, conversion tool 102 can present a user interface (UI) that allows (and in some cases guides) the customer to select, proceed in a specific order, and convert specific customized columns in a given conversion source mapping/interface.

Additional details regarding the workflows described above are presented the sections that follow.

It should be appreciated that the system architecture shown in FIG. 1 is illustrative and not intended to limit embodiments of the present disclosure. For example, as mentioned previously, although conversion tool 102 is identified as an “ODI converter” and conversion source repository 114 is identified as an “Informatica Repository,” system architecture 100 may be used to facilitate conversion between any two types of DI software products that rely on incompatible DI metadata. Further, the various entities shown in FIG. 1 may have other subcomponents or perform other functions that are not specifically depicted/described. One of ordinary skill in the art will recognize other variations, modifications, and alternatives.

### 2. Example Computer System

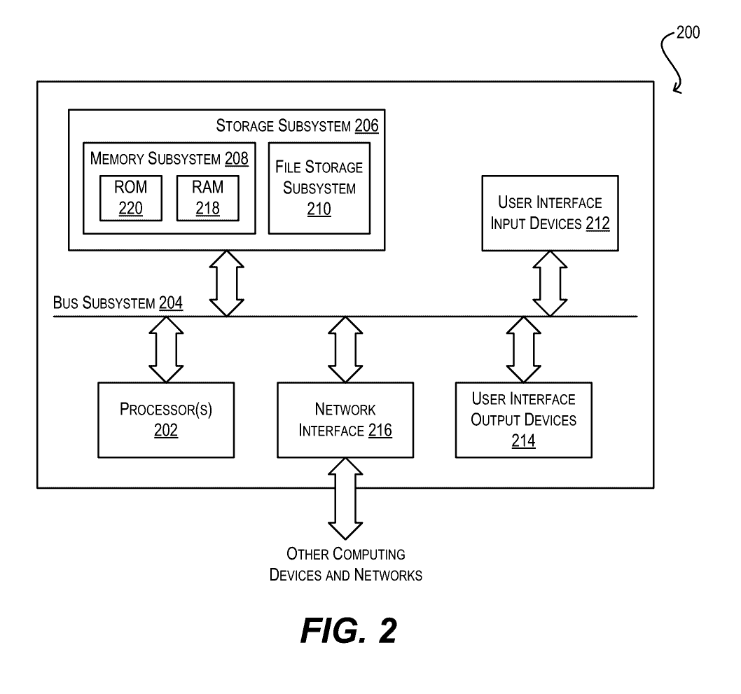

FIG. 2 depicts an example computer system 200 according to an embodiment. Computer system 200 can be used to execute conversion tool 102 of FIG. 1. As shown in FIG. 2, computer system 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple busses.

Network interface subsystem 216 can serve as an interface for communicating data between computer system 200 and other computing devices or networks. Embodiments of network interface subsystem 216 can include wired (e.g., coaxial, twisted pair, or fiber optic Ethernet) and/or wireless (e.g., Wi-Fi, cellular, Bluetooth, etc.) interfaces.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 200.

Storage subsystem 206 can include a memory subsystem 208 and a file/disk storage subsystem 210. Subsystems 208 and 210 represent non-transitory computer-readable storage media that can store program code and/or data that provide the functionality of various embodiments described herein.

Memory subsystem 208 can include a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 200 is illustrative and not intended to limit embodiments of the present invention. Many other configurations having more or fewer components than computer system 200 are possible.

### 3. High-Level Conversion Flowchart

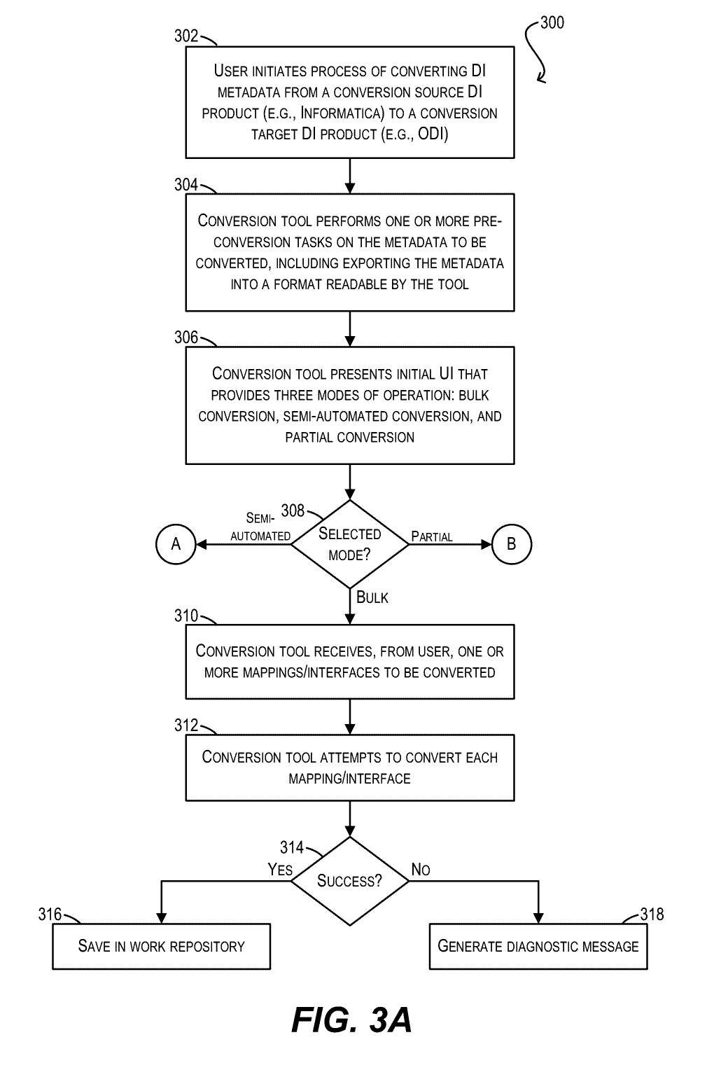

FIGS. 3A-3D depict a high-level flowchart 300 that may be carried out by conversion tool 102 of FIG. 1 for converting DI metadata between a conversion source DI product and a conversion target DI product according to an embodiment.

Starting with block 302 of FIG. 3A, a user can initiate the conversion process. In one embodiment, the DI metadata to be converted can include mappings or interfaces that define rules on how data should be extracted from a source table/file, transformed, and loaded into a target table/file. The DI metadata to be converted can also include other types of metadata, such as reusable collections of transformation objects (e.g., mapplets, expressions, filters, etc.), load plans, and so on.

At block 304, conversion tool 102 can perform one or more pre-conversion tasks. The nature of these pre-conversion tasks can vary depending on the degree of compatibility between the conversion source and conversion target DI products. For instance, in one embodiment, the pre-conversion tasks can include replicating variables and sequence generators that are used in the conversion source DI metadata into a format that is usable by the conversion target DI product. In another embodiment, the pre-conversion tasks can include identifying functions used in the conversion source DI metadata and generating a matching list of functions supported by the conversion target DI product (this list is stored in the function list properties file shown in converter ecosystem 112). In yet another embodiment, the pre-conversion tasks can include customizing aspects of the conversion target DI product to support successful conversion. A specific set of pre-conversion tasks that are applicable to an Informatica-to-ODI conversion is described in Section (4) below.

As part of the pre-conversion tasks performed at block 304, conversion tool 102 can export the conversion source DI metadata into a format that is readable by tool 102. For instance, in a particular embodiment, conversion tool 102 can export the conversion source DI metadata as one or more XML files (via the XML exporter of converter ecosystem 112). Conversion tool 102 can then store the exported metadata in one or more predefined folders on conversion source repository 114.

At block 306, conversion tool 102 can present an initial UI to the user that provides three different modes of operation: a bulk conversion mode, a semi-automated (i.e., manually assisted) conversion mode, and a partial conversion mode. In response to the initial UI, the user can select one of the three modes at block 308. If the user selects bulk conversion mode, conversion tool 102 can receive, from the user, one or more mappings/interfaces (from the folder(s) of exported metadata) to be bulk converted (block 310). In one embodiment, the user can only select certain types of “simple” mappings/interfaces for bulk conversion, such as mappings/interfaces that only include certain predefined types of objects. If the user attempts to select a complex mapping/interface, conversion tool 102 can generate a message requesting that the user convert that mapping/interface in semi-automated mode.

Then, at block 312, conversion tool 102 can attempt to convert each selected mapping/interface by parsing the mapping/interface and generating a converted version that can be used by the conversion target DI product. In one embodiment, conversion tool 102 can create this converted version by invoking one or more APIs that are exposed by an instance of the conversion target DI product.

If the conversion at block 312 is successful (block 314), conversion tool 102 can save the converted mapping/interface in work repository 118 for later use by the conversion target DI product (block 316) and flowchart 300 can end. On the other hand, if the conversion at block 312 is unsuccessful, conversion tool 102 can generate a diagnostic/error message with information regarding the failure and can save the message in diagnostic data store 120 (block 318).

Returning now to block 308, if the user selects the semi-automated conversion mode, flowchart 300 can proceed to FIG. 3B. At block 320 of FIG. 3B, conversion tool 102 can receive, from the user, a selection of a particular exported mapping/interface in conversion source repository 114 to be converted in a semi-automated manner. In response, conversion tool 102 can display, in a series of windows, the objects (also known as “instances”) included in the selected mapping/interface, sorted by object type (block 322). For example, conversion tool 102 can display all of the source objects included in the mapping/interface in a first window, all of the target objects included in the mapping/interface in a second window, all of the lookup objects included in the mapping/interface in a third window, and so on.

Upon displaying the objects of the selected mapping/interface, conversion tool 102 can receive, from the user, selections of one or more of the objects for inclusion in the converted version of the mapping/interface (block 324). As part of this step, the user can provide additional input/information to guide the conversion process. For example, the user may order the selected objects in a certain manner to achieve a successful conversion, or modify the characteristics of certain objects (such as modifying the SQL expression in an object that has an SQL override, defining ODI Knowledge Modules for a target interface, and so on).

Then, at block 326, conversion tool 102 can attempt conversion of the mapping/interface in accordance with the user's inputs. In some cases, multiple conversions may be necessary (for example, a selected object may contain one or more Lookups with SQL override), in which case multiple conversion target mappings/interfaces may be created. Like block 312 of FIG. 3A, conversion tool 102 can attempt this conversion by invoking one or more APIs that are exposed by an instance of the conversion target DI product.

If the conversion at block 326 is successful (block 328), conversion tool 102 can save the converted mapping/interface in work repository 118 for later use by the conversion target DI product (block 330) and flowchart 300 can end. On the other hand, if the conversion at block 326 is unsuccessful, conversion tool 102 can generate a diagnostic/error message with information regarding the failure and can save the message in diagnostic data store 120 (block 332). In some embodiments, after successful conversion of a first set of selected conversion source mapping objects, workflow 300 can return to block 324 again and the user can select a next set of conversion source mapping objects for conversion into the conversion target interface. Workflow 300 can then proceed through blocks 326-332 again. This part-by-part conversion can continue until all objects have been converted into the conversion target interface.

Returning once again to block 308, if the user selects the partial conversion mode, flowchart 300 can proceed to FIGS. 3C and 3D. At block 334 of FIG. 3C, conversion tool 102 can receive, from the user, a selection of a conversion source mapping/interface and a target column within the conversion source mapping/interface to be converted. In response, conversion tool 102 can parse the selected conversion source mapping/interface and display its target tables, along with a non-editable column field and field expression (block 336).

At block 338, conversion tool 102 can receive, from the user, a selection of a conversion target mapping/interface that corresponds to the conversion source mapping/interface selected at block 334. In response, conversion tool 102 can parse the selected conversion target mapping/interface and display its child yellow and blue interfaces, along with an editable column name and expression for a pre-selected column (block 340).

At block 342, conversion tool 102 can receive, from the user, specific transformations needed to add the new column(s) to the conversion target mapping/interface. As part of block 342, the user can view the existing transformations on the target column of the conversion source mapping/interface in order to figure out which transformations need to be added to the conversion target mapping/interface.

Then, at block 344, conversion tool 102 can add the received transformations to the work repository and attempt to save the conversion target mapping/interface.

Turning now to FIG. 3D, at block 346, conversion tool 102 can check whether the saving of the conversion target mapping/interface was successful. If not, conversion tool 102 can generate a diagnostic error message (block 348) and workflow 300 can end. Otherwise, conversion tool 102 can save the conversion target mapping/interface (block 350) and can receive, via the editable column field, (1) new column name(s) and (2) its column expression(s) that will be added to the target table in the conversion target mapping/interface (block 352).

At block 354, conversion tool 102 can attempt to map the selected columns to the conversion target mapping/interface. If this mapping is not successful (block 356), conversion tool 102 can generate a diagnostic error message (block 358) and workflow 300 can end. On the other hand, if the mapping is successful (block 356), conversion tool 102 can save the conversion target mapping/interface in the work repository, thereby completely the partial conversion process.

### 4. Implementation Details for Informatica-to-ODI Conversion

The remainder of the present disclosure provides various details for implementing a version of conversion tool 102 that is specifically designed to support Informatica-to-ODI conversion. This tool is referred to as the “InfatoODI converter.” The implementation details below cover (1) pre-conversion tasks to be performed by the InfatoODI converter (per block 302 of FIG. 3A), (2) an exemplary bulk conversion workflow (per blocks 310-318 of FIG. 3A), (3) an exemplary semi-automated (i.e., “DI”) conversion workflow (per blocks 320-332 of FIG. 3B), and (4) and an exemplary partial (i.e., “BI Apps”) conversion workflow (per blocks 334-360 of FIGS. 3C and 3D).

### 4.1 Pre-Conversion Tasks

There are a few objects that the InfatoODI converter doesn't handle, so in order to have complete set of objects in a converted mapping, certain objects need to be developed manually. Also certain Informatica features are not present as it is in ODI; accordingly, these features need to be added to ODI by customizing knowledge modules. All these steps, such e creating few objects manually, customizing knowledge modules to have required features to ODI, and preparing required inputs to the InfatoODI converter are handled as pre conversion tasks. The follow is an example list of tasks that may be performed as part of pre-conversion:
Development of variables
Informatica to ODI matching functions list
Knowledge module customization
Development of sequences
Building InstanceConnection.properties convertor input file
Exporting Informatica mappings using mapping exporter

### 4.1.1 Variables

Purpose:

Replicate Informatica variables and parameters in ODI as variables. These variables are used in mapping expressions/query during conversion.

Use:

These variables will be used in converted interfaces.

Process:

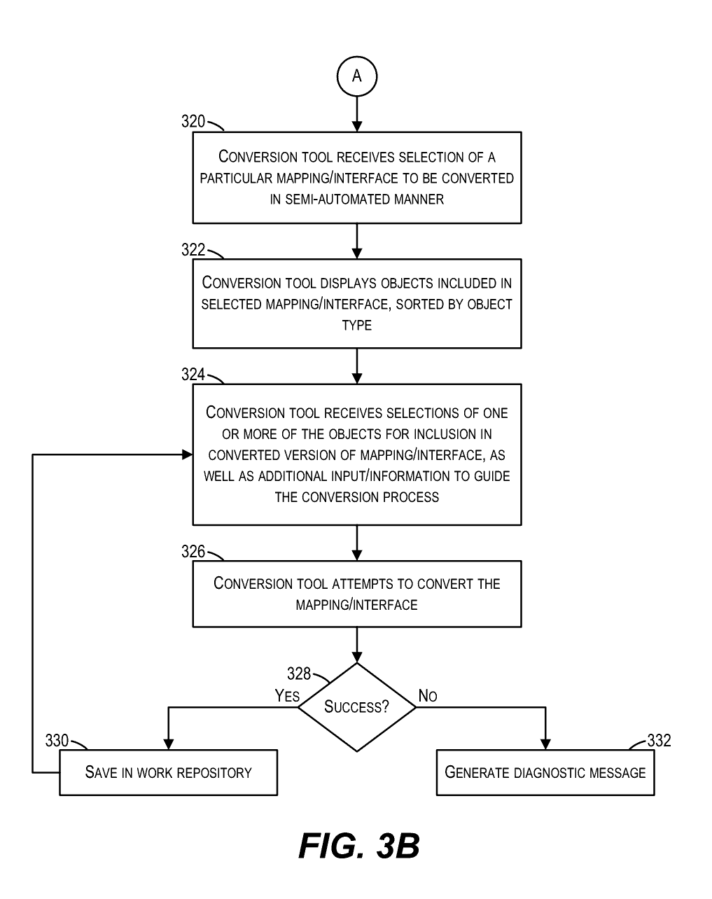

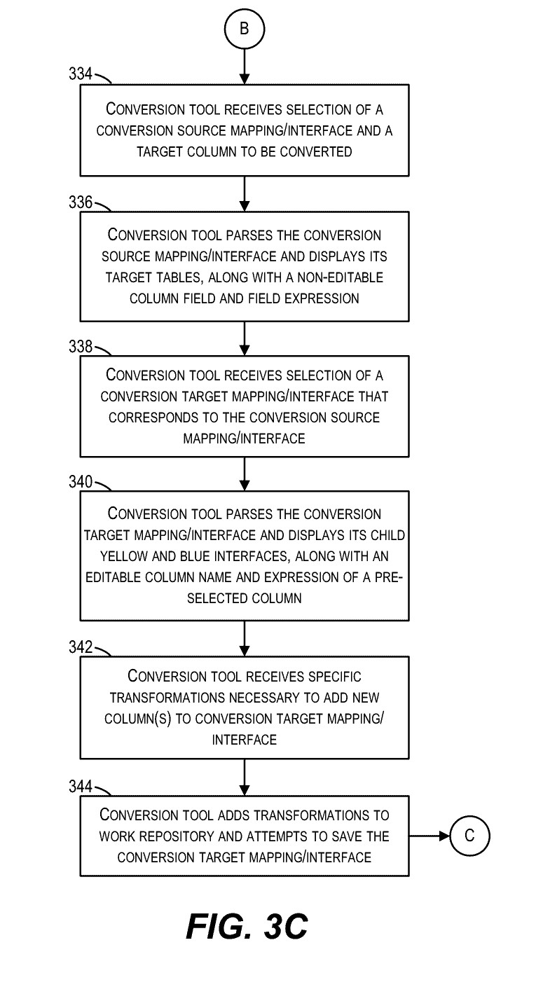

Get the list of variables mapping wise using query “Informatica Parameter & Variable List.sql.” See the logic of variable in Informatica and implement that logic in ODI. For example, FIG. 4 depicts a UI of an example Informatica variable INITIAL_EXTRACT_DATE Variable and its logic, and FIG. 5 depicts and ODI variable that has been created using the same name and logic for use in related converted interfaces. There are three types of Informatica objects. Static variable, Dynamic variable and Parameters are converted in ODI as variable. Based on Informatica variable scope (i.e., global or local) it is created into ODI Global or Project Level variable.

### 4.1.2 Functions

Purpose:

Get list of Informatica and its equivalent ODI functions. This list is necessary so that the converter knows which functions will not work in ODI so that it can log a warning/error message in diagnostics about the same.

Use:

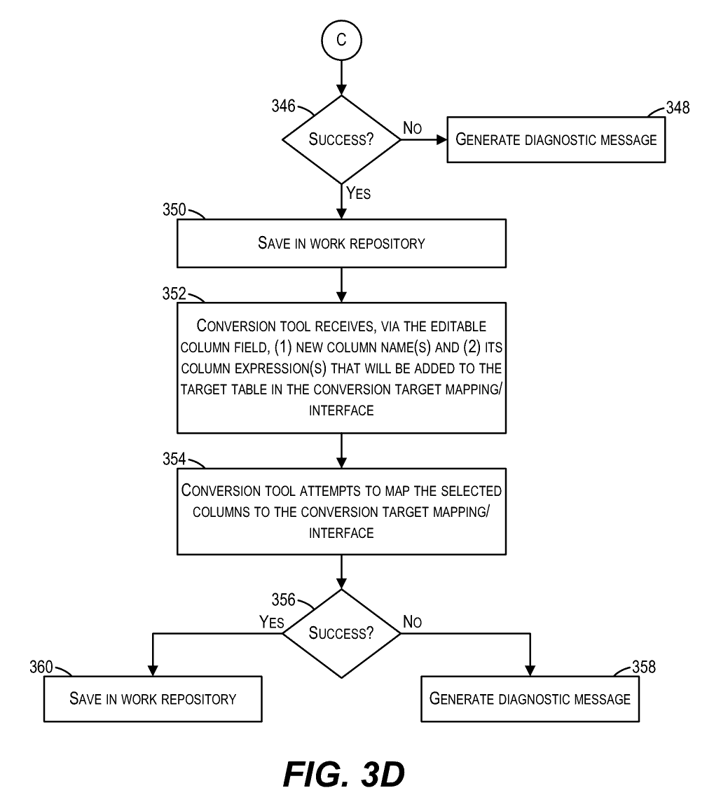

In this step, an “InfaService.properties” document is created which provides a list of functions used in Informatica mappings and their related ODI functions. This will be used to replace Informatica functions caught during conversion with related ODI functions and list out Informatica functions to diagnostics when the related ODI function is not present. FIG. 6 depicts an example of the InfaService.properties document.

### 4.1.3 Knowledge Module Modification

Purpose:

To handle the few features of Informatica in ODI that are otherwise not available with standard installation.

Use:

These customized knowledge modules will be applied on ODI Interface during conversion to get expected results.

Process:

The following are examples of the types of knowledge module modifications that may be made.

KM Customization to Handle Source Qualifier SQL Override:

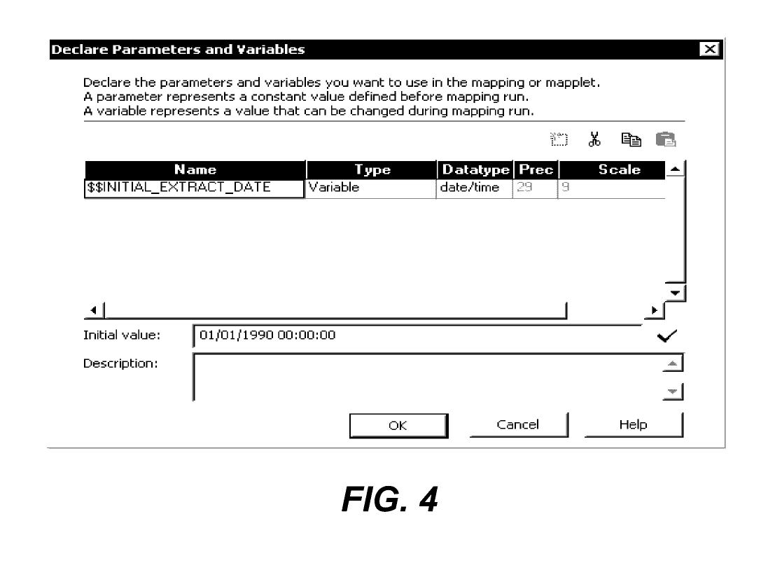

Informatica provides a Source Qualifier override feature. In order to implement this feature in ODI, the knowledge module can be modified to include a step “Generate Derived Table SQL,” which includes logic to pick the Informatica Source Qualifier override query that a user provides through the converter during conversion. The code for this is shown in FIG. 7. Further, an option can be added to the knowledge module called “OBI_SQL_OVERRIDE” that stores the Source Qualifier query of Informatica provided at the time of conversion. This knowledge module, when used in a temporary interface, will use the SQ Override query provided (i.e. with this knowledge module) so that ODI will behave same as that of Informatica to implement SQ Transformation.

KM Customization to Handle Sorter Transformation:

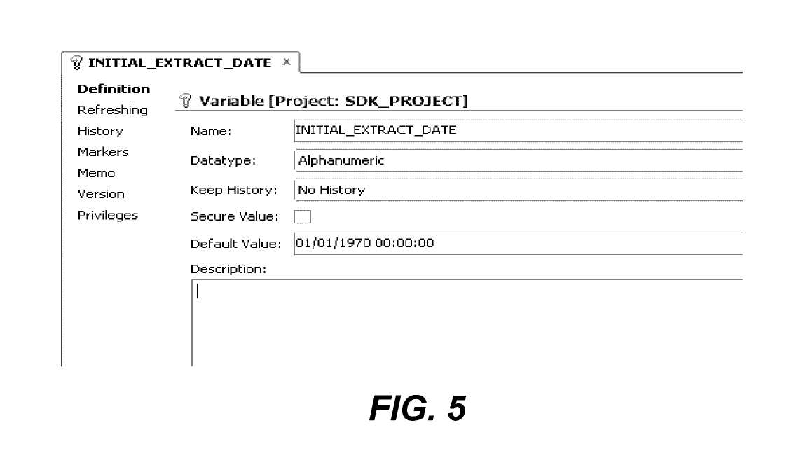

Informatica Sorter Transformation provides a feature to sort on selected columns. In order to implement this functionality in ODI, the knowledge module can be customized to do Order By on selected columns with the help of a user-defined flag. The code for this is shown in FIG. 8. This code will do Order by on columns with the “UD3” flag selected in the ODI mapping.

### 4.1.4 Sequence Generators

Purpose:

To replicate each Informatica sequence generator in ODI as a sequence.

Use:

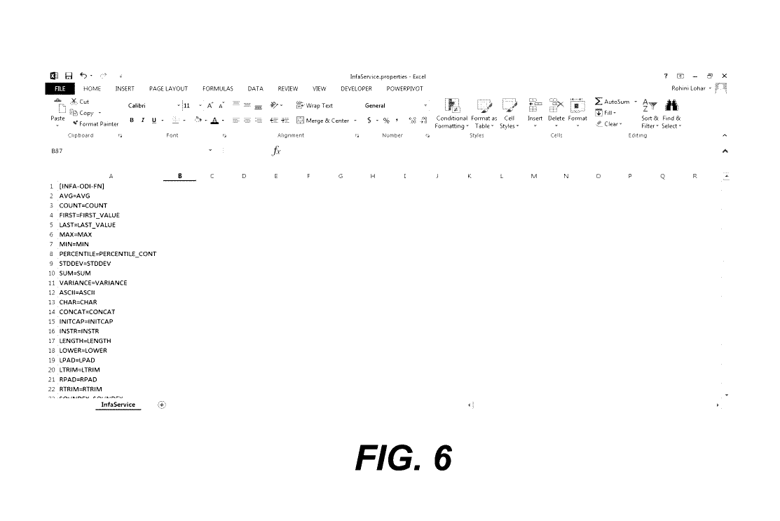

These sequences are to be created manually and will be used in ODI interface during conversion. An example sequence is shown in FIG. 9.

### 4.1.5 Instance Connection

Purpose:

To get connection details of Informatica objects like source, target, and lookup tables used in mappings.

Use:

Output of this query is placed into a file named “instanceconnection.properties” with some changes such as Informatica source connection name replaced with ODI source Model name. The InfatoODI converter uses this file during conversion to create source, target, and lookup tables in ODI models.

### 4.1.6 Mapping Exporter

Purpose:

To read user specified Informatica folders and export all the mappings from Informatica.

Use:

Mapping Exporter batch file “MEF.BAT” is used to export the mapping XMLs from Informatica folders. These exported XMLs will be an input source for the InfatoODI converter.

### 4.2 DI Conversion

DI conversion refers to semi-automated conversion of Informatica mappings to ODI interfaces. The pre-requisites for DI conversion are that the following files/details (described previously above) should be saved in the installed directory: (1) instance connection file, (2) export of the mapping from Informatica, and (3) function list of Information file.

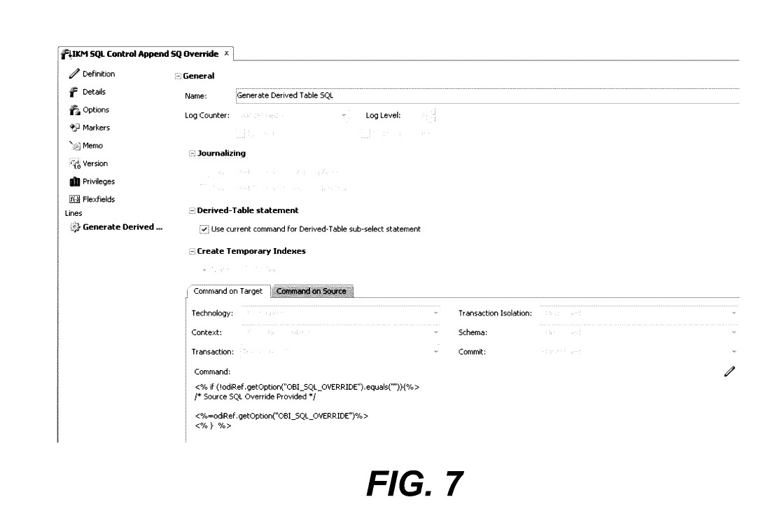

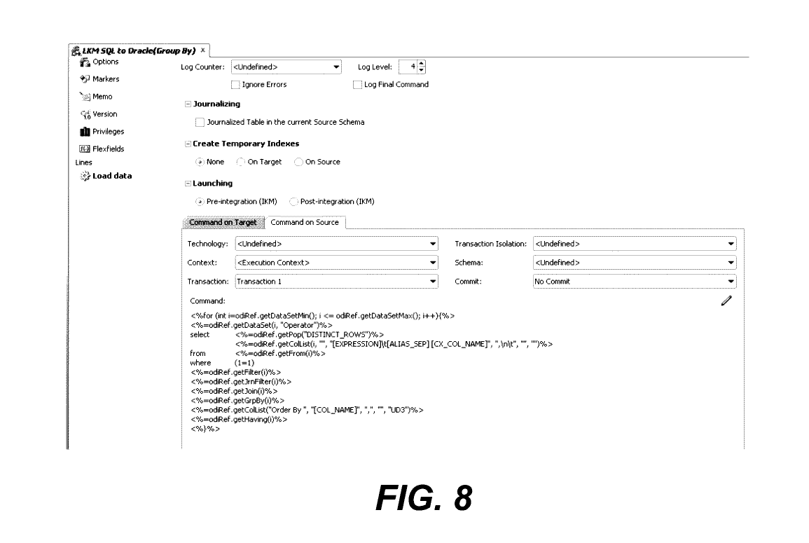

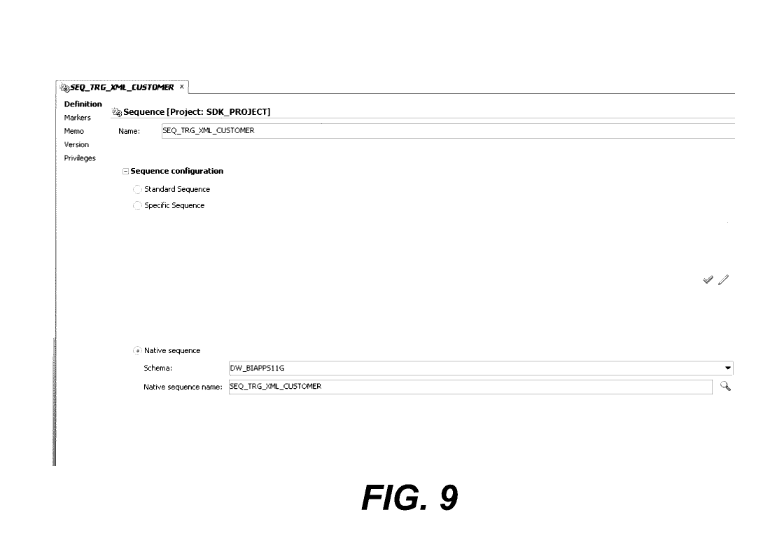

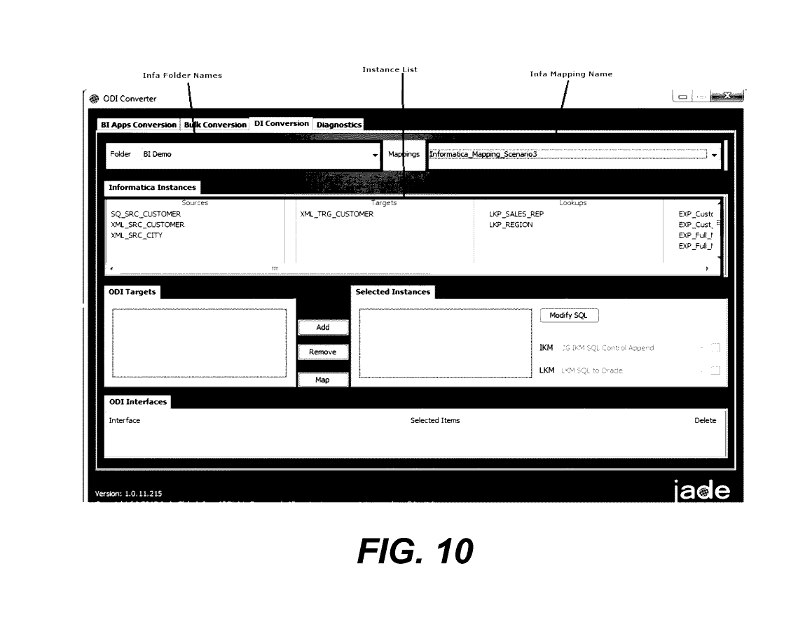

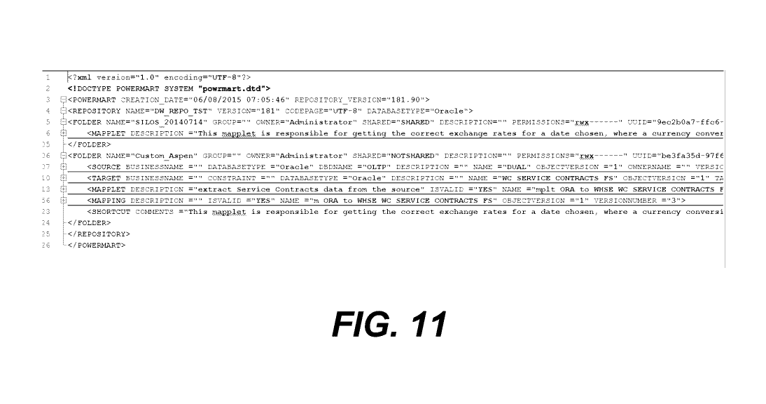

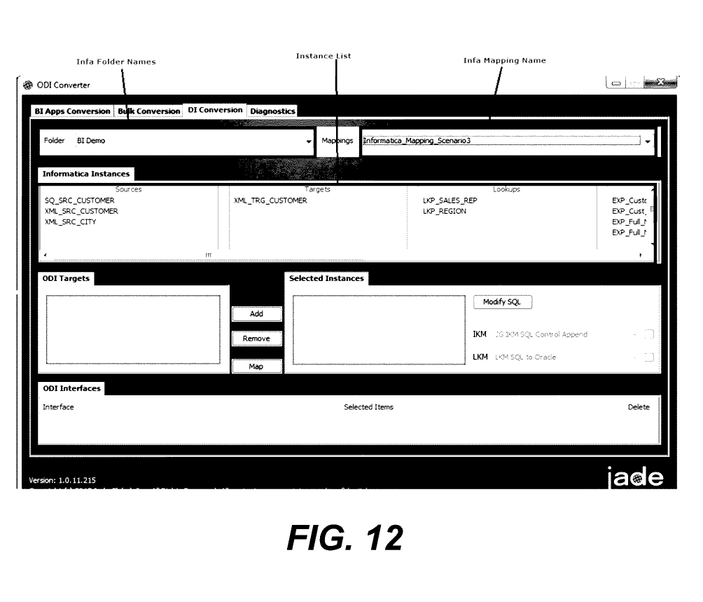

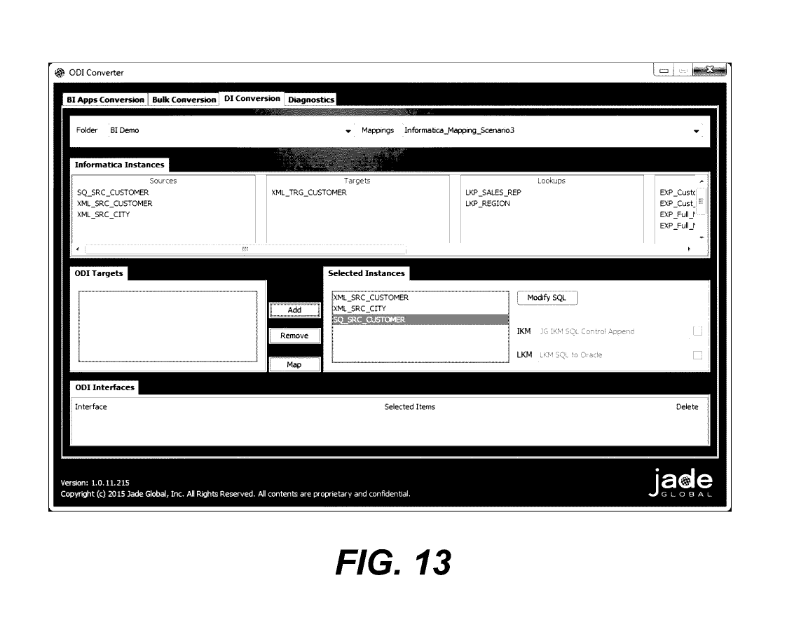

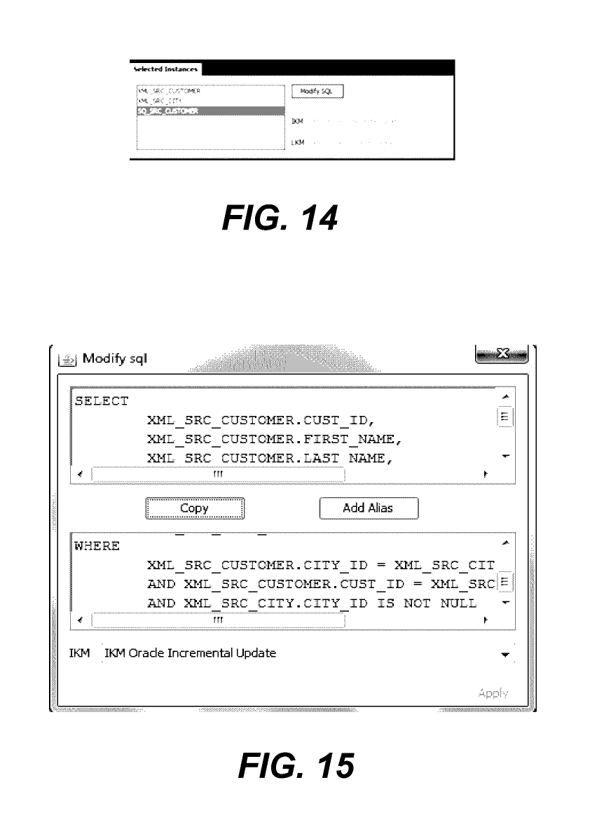

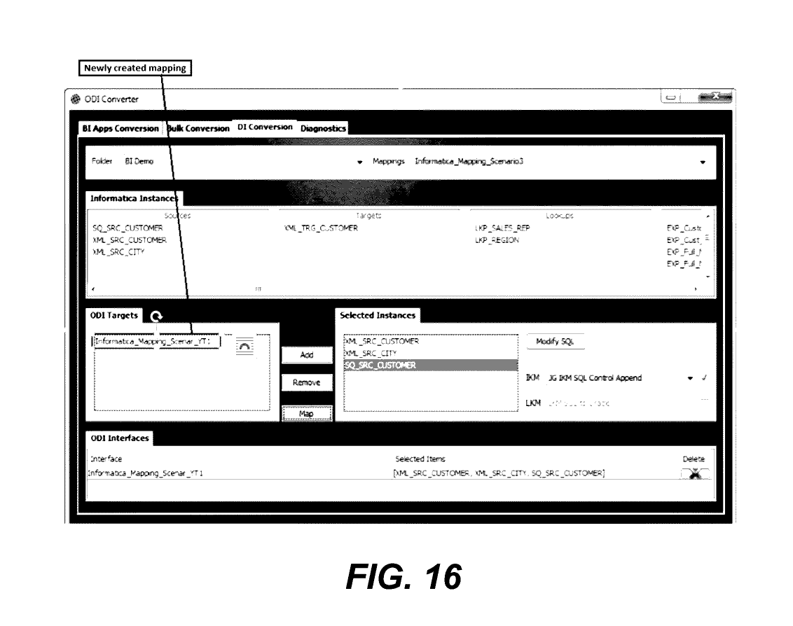

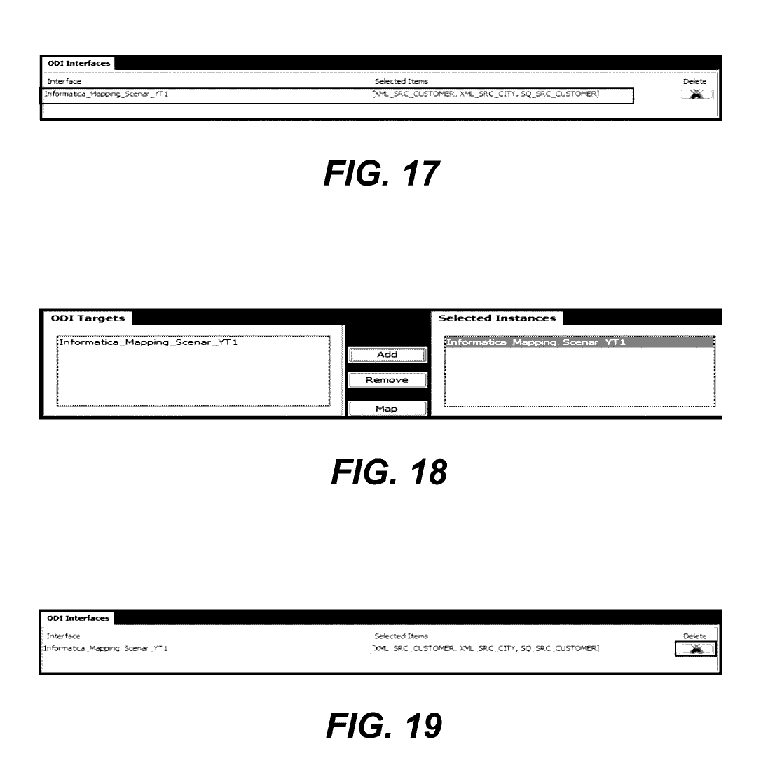

The following is an example DI conversion workflow:
Create a new interface
   Parse XML file using XML parser
      Navigate to “DI conversion” tab to convert Category-2 Informatica (INFA) mappings (shown in FIG. 10).
      Folder combo box (drop down list) will show list of folders in which XML export of mappings are pre-stored. Mapping combo box will show XML mappings present within selected folder. Select a mapping to be converted here.
      In the back end, the selected mapping is parsed by the XML parser as below:
         Input to XML parser is the Export file of the mapping selected in the mapping combo box.
         XML parser reads the Elements from the XML file provided as input as shown in FIG. 11.
         As it reads the XML elements, the XML parser stores them in a java objects called Java beans.
   Store all information from XML file
      Once the XML Parsing is done, use predefined Java Beans to store information of each element present in Informatica mapping, which can include sources, targets, lookups, expressions, filters/routers, port connectors and others (Union, Sorter, Joiner, Sequence generator, Update strategy, etc.).
   Display retrieved information from XML file in UI
      After retrieving all the information related to mapping, display the information in respective boxes of the converter UI as shown in FIG. 12.
   Select instances from the Informatica instances list to convert the mapping
      From the UI, a user can select the instances displayed and add it to the Selected instances List, which will create ODI interface.
      We select the element and add it to the selected list, and select appropriate knowledge module from drop down list.
      There are 2 knowledge module combo boxes i.e. IKM (Integration knowledge module) and LKM (Load knowledge module) which are retrieved from ODI itself.
      Select the Instances by clicking on Add button; these instances will be used for converting the mappings. For instance, we can select the sources and source qualifier to create the yellow interface.
      The list of selected instances are displayed in Selected Instances section as shown in FIG. 13.
      For removing any instance from the list of selected instances, select the instance and click on Remove button.
      The following transformations act as a logical breakpoint at which a temporary Interface known as Yellow Interface is created. These transformations should be last in the selected list.
         Source qualifier
         Back to back lookups
         Filter
         Router
         Aggregator
         Sorter
         Expression (may be necessary in an exceptional case)
      Also tool is built to be able to have breakpoint at any transformation making it more flexible. Hence any transformation can be break point. Above breakpoint list are must breakpoints but there is no limitation. As a standard practice, it is recommended to have minimal breakpoints.
      An interface that uses a yellow interface and populates target tables is termed as a blue Interface. If the last selected element is target, the converter creates a blue Interface.
      Note that the instances that are meant to be selected as the target for yellow or blue interfaces should be selected as the last instance in the Selected Instances section.
   Parse SQL Override query using SQL parser
      If the last selected instance is a source qualifier that has an SQL Override then there are few additional steps required.
      Expressions in SQL should have an alias same as target field names. Using the converter we can add these aliases as explained in the following steps:
         Select Source Qualifier which will enable Modify SQL button (shown in FIG. 14).
         After clicking on Modify SQL button, a new window will pop-up (shown in FIG. 15).
         The upper section shows the existing SQL; the user can copy the existing SQL to the bottom section by clicking on Copy button.
         Alias can be added to the topmost select clause of the query by clicking on Add Alias button.
         When you click on Add Alias button it will pass the SQL Query to SQL parser as an input where it will be resolved to match with ODI compatible format.
         Alternatively, user is provided with an option to select the IKM in pop-up screen
         After you click Add button it will set SQL query in the ODI KM.
         User should click on Map button in order to proceed with conversion.
   Process the selected elements to create ODI interface
      When user clicks on Map button, the converter will process the selected elements as follows:
         For selected sources it will retrieve its properties like its column name, datatypes.
         Using details stored in Java beans, for each columns, complete expression is derived from start till end for selected elements.
         Likewise it will retrieve all the details about each instance from the Java beans.
   Create ODI objects by invoking ODI APIs:
   The InfatoODI converter uses Oracle's ODI APIs to create the different ODI objects without using ODI studio.
   It retrieves attributes of each selected Instance and invokes the respective ODI APIs to create the object in ODI work repository.
   After successful conversion it will show a success message; this message is shown for one combination of selected items. The user will need to select remaining items to convert complete mapping.
   If there is any exception during conversion, the converter will show a message for the failure of mapping. It will make an entry of exception thrown in a diagnostics file.
Verify the newly created interfaces
   The newly created mapping in ODI will be displayed in the ODI Targets section of the converter UI (shown in FIG. 16).
   For this it will invoke methods in backend to retrieve the interfaces present in ODI.
   The instances used while creating the new mapping are available in ODI Interfaces section (shown in FIG. 17).
   The user can re-use the newly created interface for generating other Interfaces, by selecting the newly created interface from the ODI Target section and clicking on Add button (shown in FIG. 18).
Delete the newly created interfaces
   The newly created mapping can be deleted from ODI by clicking on Delete button in the ODI Interfaces section for the given interface (Shown in FIG. 19).
   For this it will invoke methods in the backend to delete the interfaces present in ODI by passing selected mapping name as input.

### 4.3 Bulk Conversion

Bulk conversion operates similarly to DI conversion, but there is no manual intervention required. This is fully automated process and will start converting all selected mappings one by one. The converter has inbuilt intelligence to derive complete end to end expression for each of the target columns. In certain embodiments, there is a limitation that only “simple” mappings can be converted using bulk conversion. Accordingly, medium and complex mappings should be converted using DI conversion.

### 4.3.1 Types of Mappings/Transformations Handled

Simple mappings are those which only include the following transformations:
Source
Target
Source qualifier without SQL override
Expressions without self-calling variables
Update strategy
Connected lookup without SQL override
Unconnected lookup without SQL override

For mappings that have any transformations other than those listed above, the converter can display a pop-up message indicating that the mapping cannot be converted using bulk conversion. Such mappings may be converted using DI conversion.

### 4.3.2 Mapping Selection and Removal

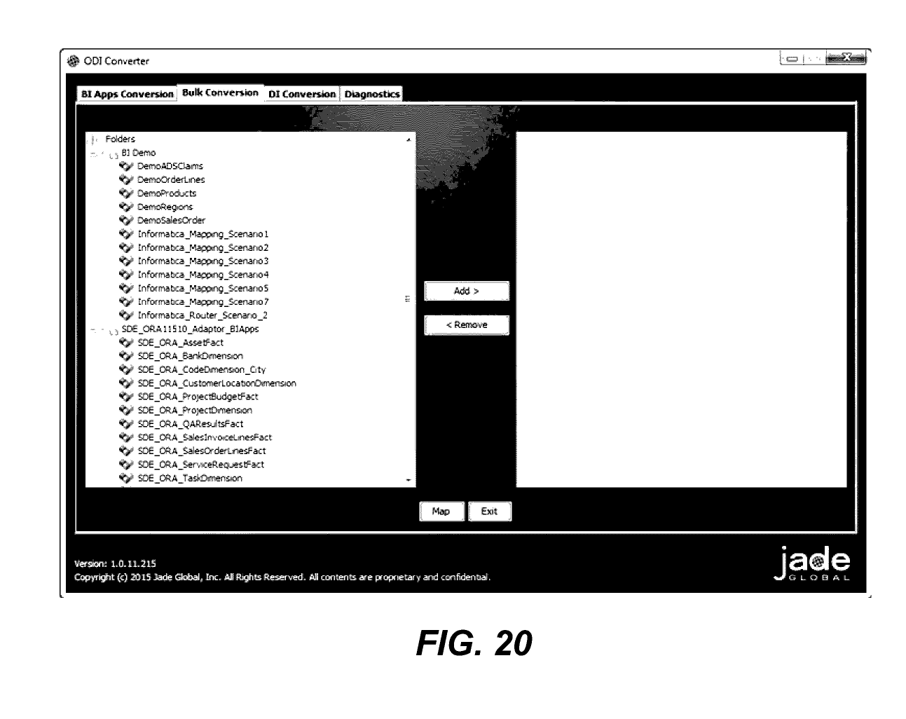

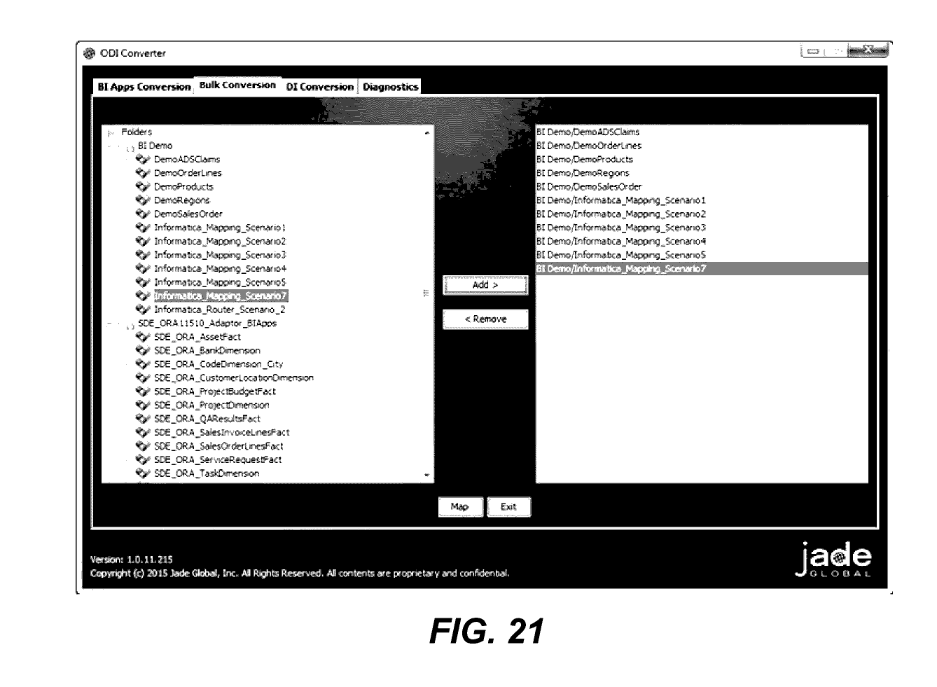

XML of mappings can be displayed as a tree structure in the left window pane of the converter UI (see FIG. 20). We can expand the tree and select multiple XML/Mappings and click on Add button to add mappings for conversion. Added mappings will be displayed on the right half of window pane (see FIG. 21). Similarly, the remove button will remove selected mappings. A multi-select option is available.

### 4.3.3 Mapping Conversion

After adding a mapping, upon clicking the Map button, the converter will invoke the backend program that will start converting the selected mappings one by one. As part of this process, the converter derives the end to end expression of each target column of the Informatica mapping using the XML parser. The converter then uses Oracle's ODI APIs to create different ODI objects in the ODI work repository.

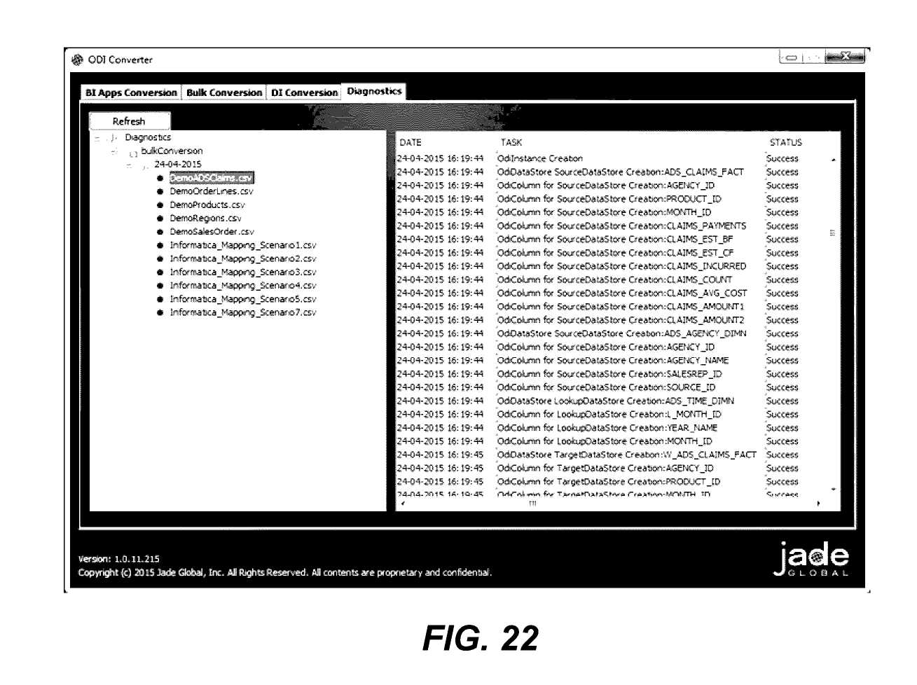

Upon successful conversion of each mapping, the converter will display an appropriate success message. If the converter finds a mapping that is beyond its inbuilt intelligence, it can display a message that it is not able to handle it and the mapping should be converted using DI Conversion. Logs of each of the converted/attempted mappings are maintained under the Diagnostics tab for future reference (see FIG. 22). These logs can contain all steps, their conversion status, and error codes/messages.

### 4.4 BI Apps Conversion

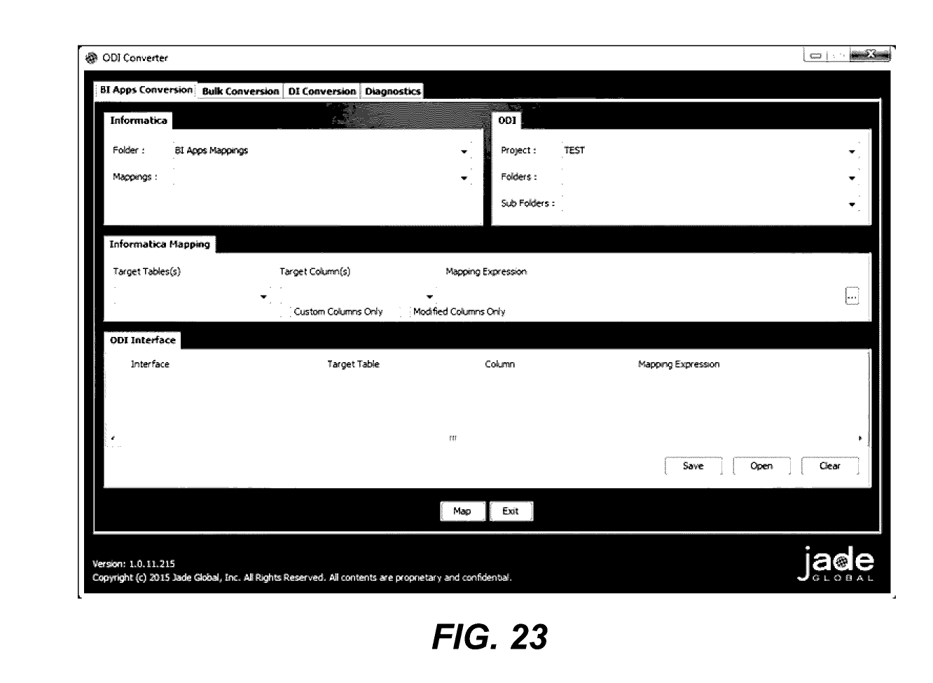

BI Apps conversion is designed for handling Category-1 type of customizations. This will assist the user to add only custom columns to the existing Interfaces in ODI. FIG. 23 depicts the general UI of the BI Apps conversion tab.

### 4.4.1 Informatica Section

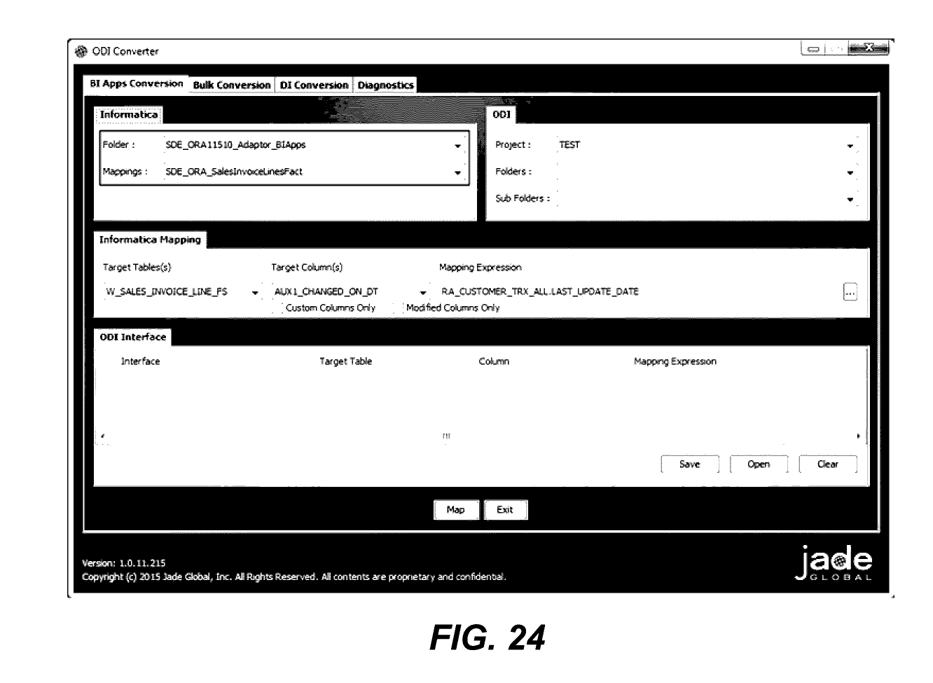

The folder dropdown list in this section will show the list of folders into which XML export of mappings are saved, and the mapping dropdown will shows list of XML mappings present within selected folder (see FIG. 24). After the user selects a mapping following steps are executed by the converter: (1) XML is parsed when mapping for selected mapping, and (2) all the transformations and instances are stored in java beans.

### 4.4.2 Informatica Mapping Section

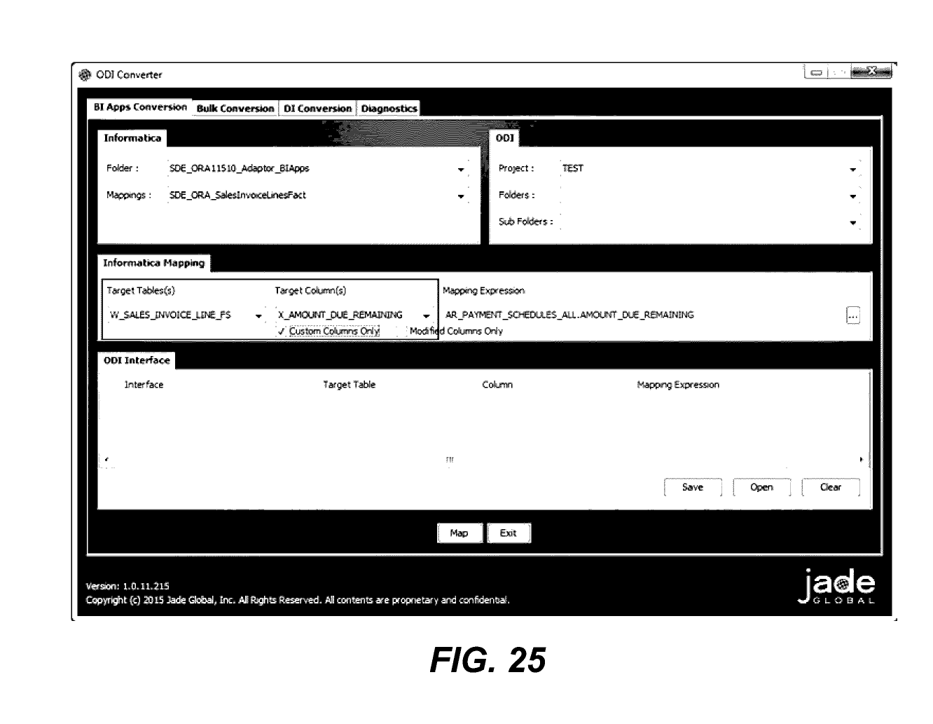

In this section, the target table(s) shows the list of target tables present in the selected mapping, and target column(s) shows the list of columns in the selected target table (see FIG. 25). The “Custom Columns Only” checkbox can be selected to list only custom columns. This will list all columns that are prefixed with “X_” which is standard practice of BIApps customization. The “Modified Columns Only” checkbox can be selected to list only modified columns. This checkbox will invoke the Java function that will compare expression of each column of Custom mapping with that of BIApps mapping and will display only those columns that have different expressions.

Based on the selected column of the mapping, the mapping expression is retrieved using a searchConnector method which calculates the expression by passing through each connector element in XML. Further, by clicking on the button next to the “Mapping Expression” textbox, the complete mapping expression will be displayed in a popup box.

### 4.4.3 ODI Section

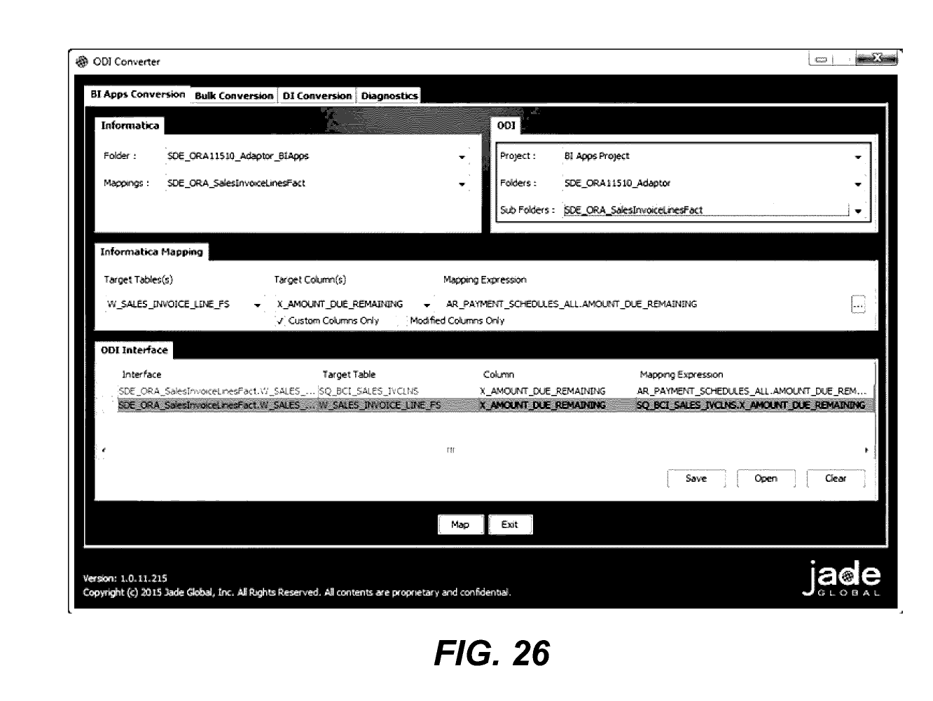

In this section, the user can select the project, folder, and sub-folder (see FIG. 26). The mapping should be the same as the mapping selected in the Informatica section.

### 4.4.4 ODI Interface Section

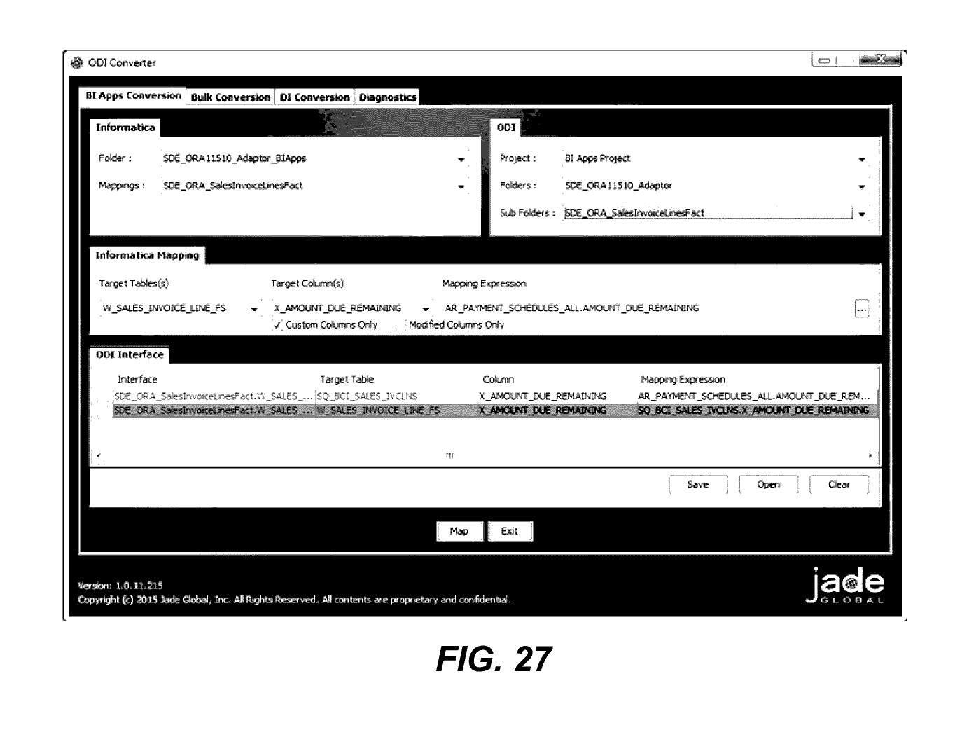

ODI APIs are used to retrieve interface information in the selected folder and subfolder and display the interface information in this section (see FIG. 27). The ODI Interface section has 5 columns:
Interface Name
Target table name of the interface
Column Name—this an editable field that is used to create the new column in ODI
Mapping Expression—this is an editable field can be used to edit the mapping expression, if required
Transformations—this includes a View button that can be used to view the transformations present in the Informatica mapping expression as well as in the ODI interface.

The user can select the checkboxes for the interfaces to which he/she wants to map the new column. In addition, the user can click on the View buttons (in the Transformations column) to view the transformations for each interface. This can be useful if the Informatica expression includes some transformations that are not present in ODI (e.g., new source, new lookup, etc.).

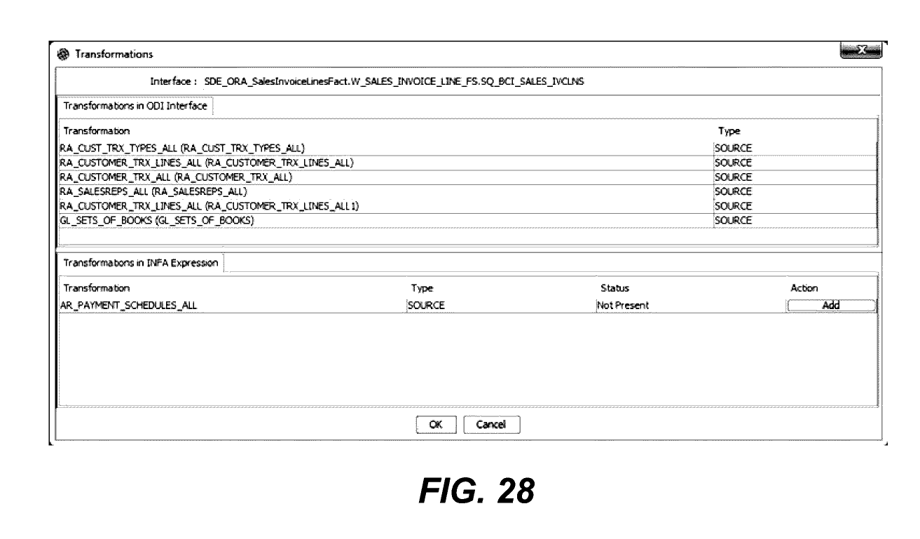

Upon clicking the View button, a “Transformations” window will open (see FIG. 28). This window contains a “Transformations in ODI Interface” section, which lists the transformations present in the selected ODI interface. ODI APIs are used to retrieve the list of transformations. This list is derived from the current dataset's getSourceDataStores method. The Transformations window also contains a “Transformations in INFA Expression” section. If the transformation is not present in the ODI interface, this section will display an add button in the Action column. The user can add the new/customized transformation in ODI using this button. The name of each transformation is compared with transformations in ODI and, based on that, the Add button will display.

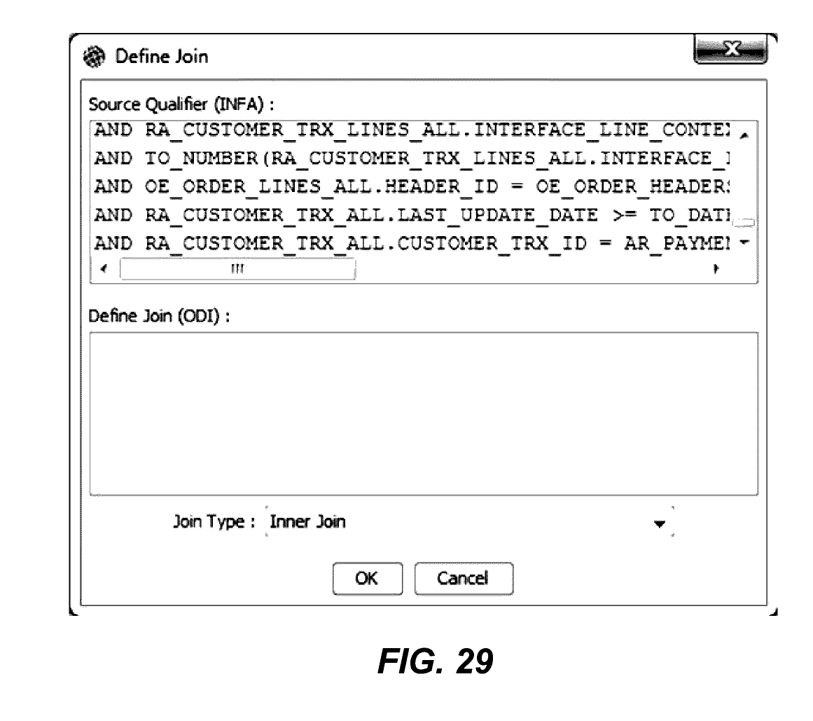

If the user wishes to add a new source, the user should provide a join statement for that source. This can be performed in a “Define Join” window that will display when the user clicks on the Add button for Source (see FIG. 29). In the upper part of the window, the user can refer to the Source Qualifier SQL Query/User Defined Join which is retrieved from stored java beans to define the new join. In the bottom of the window, the user can enter the necessary joins that he/she picks from upper part of window and user can also select Join Type for the new Join and click OK. ODI APIs are used to first create source data source and then to add that data source in current interface. A message window will popup upon successful completion.

If the user wishes to add a new lookup, the user can click on the Add button and the lookup will be created automatically. The join condition for the lookup is retrieved from the stored java beans automatically. ODI APIs are used to first create lookup data source and then to add that data source in current interface as a lookup.

### 4.4.5 Saved Columns

As shown in FIG. 26, there are three buttons at the bottom of the ODI Interface section: In BI Apps Conversion tab, there are three buttons at the bottom of ODI Interface section: (1) Save, which saves the columns the user has checked using the checkboxes, (2) Open, which opens the list of columns that have been saved, and (3) Clear, which clears the list of columns that have been saved.

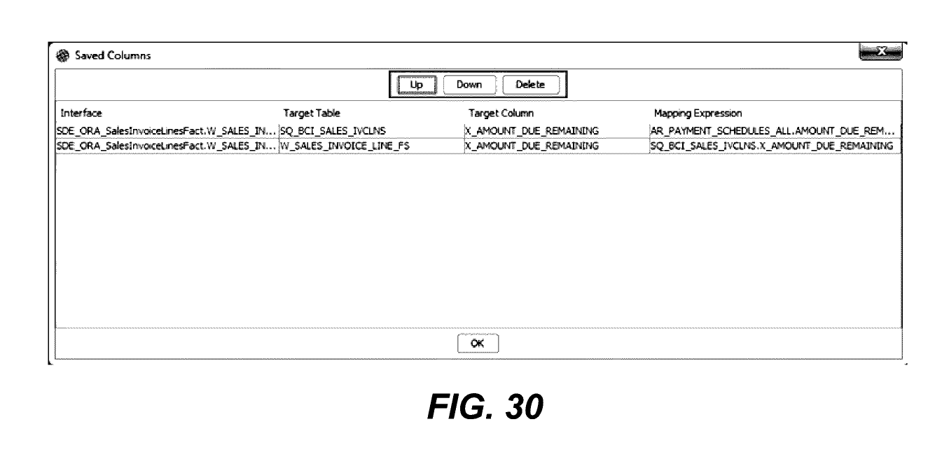

In the Saved Columns list (shown in FIG. 30), the user can rearrange the order of mapping of the columns by using the Up, Down, and Delete buttons at the top.

### 4.4.6 Creating New Column Expression in ODI Interface

Clicking on the Map button at the bottom of the BI Apps Conversion UI (see FIG. 27) will start the mapping process. When this mapping process starts, ODI APIs are called to first create the new column in the data source and then to set expression for that newly created column in a selected ODI Interface. In case of a yellow interface, the column is created in Temporary Target Data Source and in case of a blue interface, the column is created in Target Data Source which is present in given model. A success or failure message will appear upon completion of the mapping process.

### 4.5 Diagnostics

The InfatoODI converter captures all exceptions/errors/warning thrown during conversion process. For example, the converter can capture exceptions or errors in the following scenarios:
Scenarios that are not handled in Java code of the converter
ODI errors and warnings encountered during ODI API calls
Error/Exception encountered during XML Parser
Error/Exception encountered during SQL Parser
Any DB error encountered while running SQLs embedded within the converter

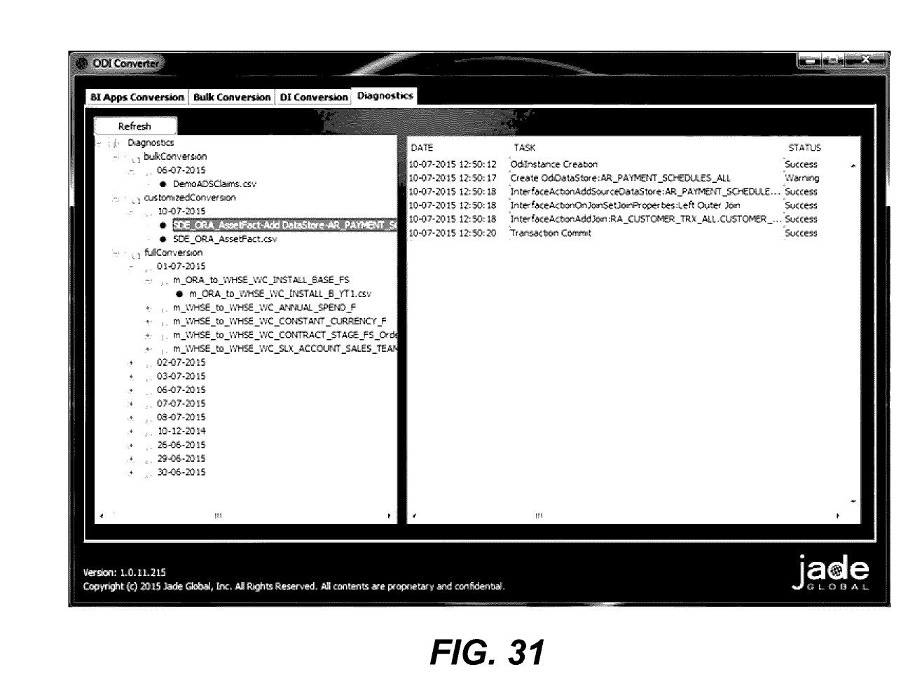

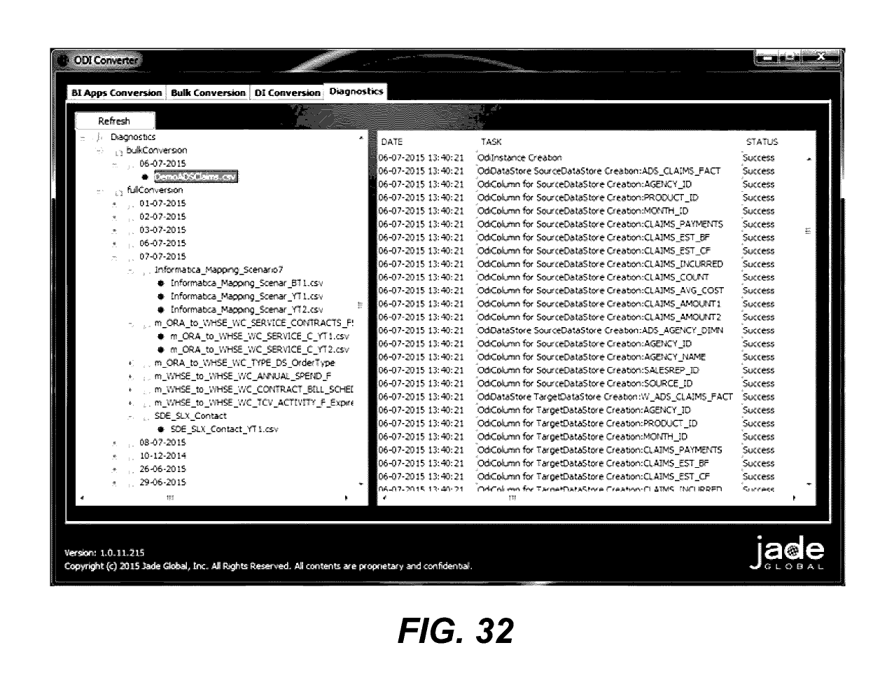

Hence the converter maintains a log of each and every step that is executed during the process of conversion. Conversion can happen from 3 screens, BIApps, DI and Bulk. Logs for all three screens are maintained in separate folders (shown in FIGS. 31 and 32).

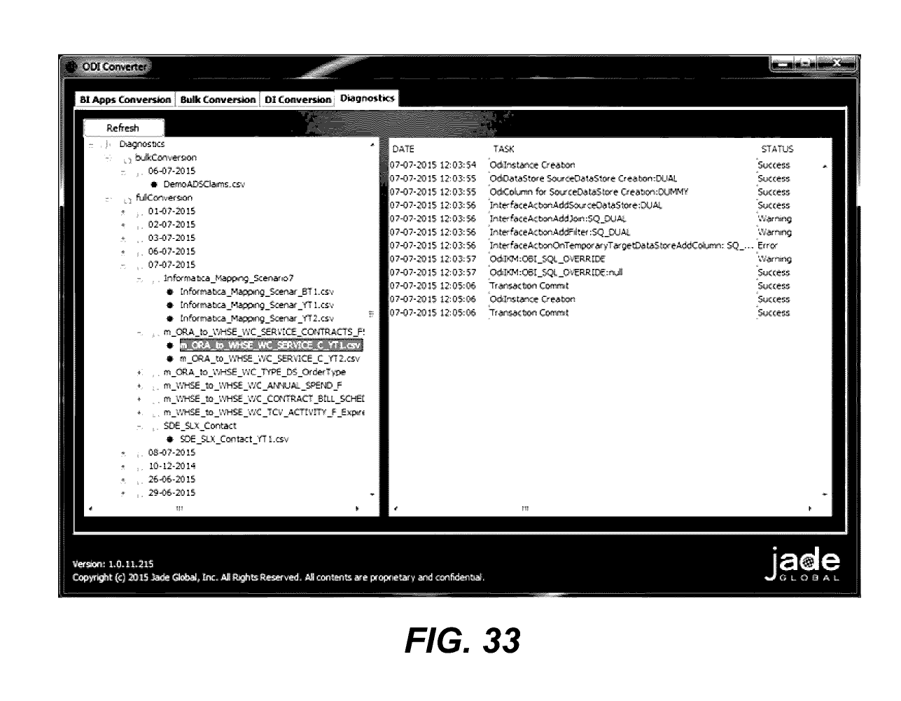

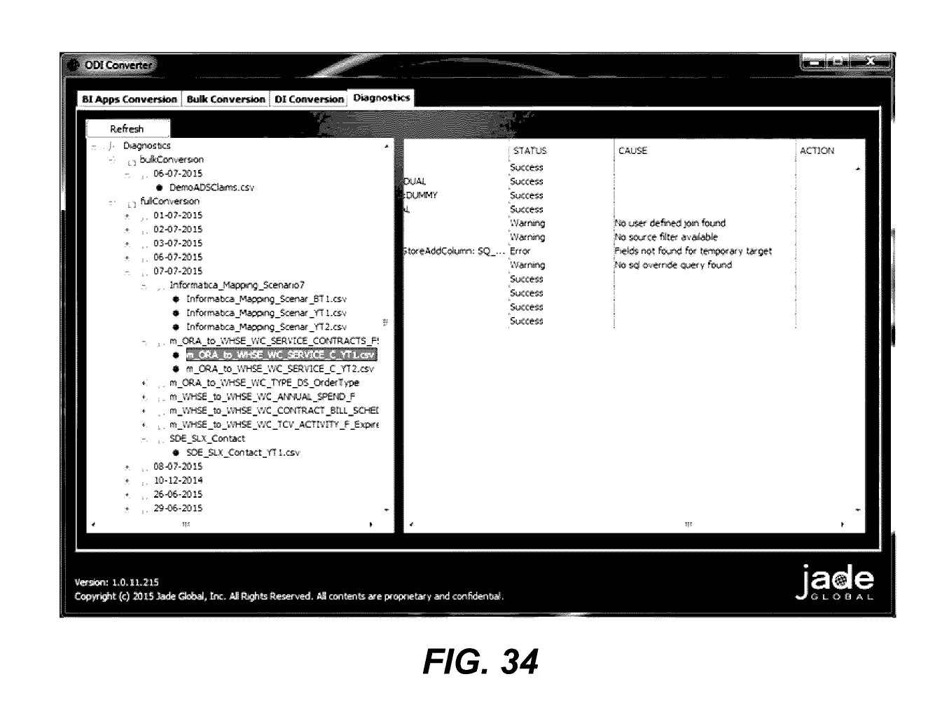

As can be seen in FIGS. 31 and 32, a tree structure is maintained for the logs. The root folder is named “Diagnostics,” which will include three subfolders (one for each conversion screen): BIApps (CustomizedConversion), DI (FullConversion), and Bulk (bulkConversion). A second level of subfolder will be “Date” and a third level of subfolder will have same name as the mapping being logged. Within this third level subfolder, a CSV file is maintained to capture the log for each converted ODI Interface. For each task executed during the creation of an interface, its timestamp, status, cause of error/warning and possible corrective action are captured in the CSV log format (see FIGS. 33 and 34).

Double clicking on any log file will open the log file. Note that if one mapping is converted on two different days, a separate log is maintained under two different date folders. If one mapping is converted twice on same day, then the first log may be overwritten.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
executing, by the computer system, one or more pre-conversion tasks with respect to first data integration (DI) metadata used by a first DI product, the one or more pre-conversion tasks including exporting the first DI metadata into an intermediate format; and
converting, by the computer system, the first DI metadata from the intermediate format into second DI metadata usable by a second DI product, the second DI product being different from the first DI product.

2. The method of claim 1 wherein the converting is perform in an automated or semi-automated manner.

3. The method of claim 1 wherein the converting comprises:
presenting, to a user, a user interface that enables selection of one of three conversion modes.

4. The method of claim 3 wherein the converting further comprises:
if the user selects the first conversion mode, executing a workflow for performing a bulk conversion of the first DI metadata into the second DI metadata;
if the user selects the second conversion mode, executing a workflow for performing a semi-automated conversion of the first DI metadata into the second DI metadata; and
if the user selects the third conversion mode, executing a workflow for performing a partial conversion of the first DI metadata into the second DI metadata.

5. The method of claim 1 wherein the first DI product is Informatica and the second DI product is Oracle Data Integrator (ODI).

6. The method of claim 1 wherein the one or more pre-conversion tasks further include:
identifying a list of variables used in the first DI metadata; and
replicating the variables for use in the second DI metadata.

7. The method of claim 1 wherein the one or more pre-conversion tasks further include:
identifying a list of functions used in the first DI metadata; and
generating a file that associates the list of functions with corresponding functions supported by the second DI product.

8. The method of claim 1 wherein the one or more pre-conversion tasks further include:
identifying features used in the first DI metadata that are not supported by the second DI product; and
customizing one or more knowledge modules of the second DI product to support the features.

9. The method of claim 1 wherein the one or more pre-conversion tasks further include:
identifying sequence generators used in the first DI metadata; and
creating sequences corresponding to the sequence generators for use in the second DI metadata.

10. The method of claim 1 wherein the one or more pre-conversion tasks further include:
identifying connection details of source, target, and lookup objects in the first DI metadata; and
generating a file that includes the connection details.

11. The method of claim 1 wherein the intermediate format is XML.

12. The method of claim 4 wherein executing the workflow for performing a bulk conversion of the first DI metadata into the second DI metadata comprises:
receiving a selection of one or more mappings in the first DI metadata;
attempting automatic conversion of each of the one or more mappings;
if the automatic conversion is successful, storing the converted mapping in a work repository accessible by an instance of the second DI product; and
if the automatic conversion is unsuccessful, generating a diagnostic message for user review.

13. The method of claim 12 wherein the conversion is performed by invoking one or more APIs exposed by the instance of the second DI product.

14. The method of claim 4 wherein executing the workflow for performing a semi-automated conversion of the first DI metadata into the second DI metadata comprises:
receiving a selection of a mapping in the first DI metadata;
presenting objects included in the selected mapping to the user;
receiving, from the user, selections of one or more of the presented objects and input to guide the conversion process; and
attempting conversion of the selected mapping based on the selected objects and received input.

15. The method of claim 4 wherein executing the workflow for performing a partial conversion of the first DI metadata into the second DI metadata comprises:
receiving a selection of a first mapping in the first DI metadata and a target column in the mapping;
receiving a selection of a second mapping the second DI metadata that corresponds to the first mapping;
receiving one or more transformations to be added a new column of the second mapping in view of existing transformations in the target column of the first mapping;
adding the one or more transformations to the new column of the second mapping; and
saving the second mapping in a work repository accessible by an instance of the second DI product.

16. The method of claim 1 wherein the one or more pre-conversion tasks further include:
running a discovery program to identify types of transformations in the first DI metadata;
running the discovery program to identify a number of components for each transformation used in the first DI metadata;
providing an assessment of the complexity of an environment associated with the first DI metadata; and
assessing the complexity of each component in the first DI metadata.

17. A non-transitory computer readable storage medium having stored thereon program code executable by a processor, the program code comprising:
code that causes the processor to execute one or more pre-conversion tasks with respect to first data integration (DI) metadata used by a first DI product, the one or more pre-conversion tasks including exporting the first DI metadata into an intermediate format; and
code that causes the processor to convert the first DI metadata from the intermediate format into second DI metadata usable by a second DI product, the second DI product being different from the first DI product.

18. A computer system comprising:
a processor; and
a non-transitory computer readable medium having stored thereon program code that, when executed by the processor, causes the processor to:
execute one or more pre-conversion tasks with respect to first data integration (DI) metadata used by a first DI product, the one or more pre-conversion tasks including exporting the first DI metadata into an intermediate format; and
convert the first DI metadata from the intermediate format into second DI metadata usable by a second DI product, the second DI product being different from the first DI product.
